(19) United States
(12) Patent Application Publication
(10) Pub. No.: US 2024/0318621 A1
(43) Pub. Date: Sep. 26, 2024

(54) SUBMERSIBLE POWER PLANT

(71) Applicant: Minesto AB, Västra Frölunda (SE)

(72) Inventor: Björn BERGQVIST, Göteborg (SE)

(73) Assignee: Minesto AB, Västra Frölunda (SE)

(21) Appl. No.: 18/573,282

(22) PCT Filed: Jun. 23, 2022
(86) PCT No.: PCT/EP2022/067241

§ 371 Date: Dec. 21, 2023

(30) Foreign Application Priority Data
Jun. 24, 2021 (SE) 2150820-5

(51) Int. Cl. F03B 13/10; B63G 8/00; B63G 8/04

(52) U.S. Cl. CPC F03B 13/10; B63G 8/001; B63G 8/04; B63G 2008/002; F05B 2220/706

(57) ABSTRACT

The invention relates to a submersible power plant for producing electrical power. The submersible power plant comprises a structure and a vehicle comprising at least one wing. The vehicle is arranged to be secured to the structure by means of at least one tether and the vehicle is arranged to move in a predetermined trajectory by means of a fluid stream passing the wing during operation of the submersible power plant. The submersible power plant further comprises at least one turbine connected to a generator, where the at least one turbine is connected to a rear edge rear edge of the wing and wherein the generator is arranged inside the wing of the vehicle.

### CROSS-REFERENCE TO RELATED APPLICATIONS

This application is a U.S. national stage application under 35 U.S.C. § 371 of International Application No. PCT/EP2022/067241, filed Jun. 23, 2022, which claims the priority of SE Application No. 2150820-5, filed Jun. 24, 2021. The entire contents of each priority application is incorporated herein by reference.

### FIELD OF THE DISCLOSURE

The invention relates to a submersible power plant for producing electrical power. The submersible power plant comprises a structure and a vehicle comprising at least one wing. The vehicle is arranged to be secured to the structure by means of at least one tether. The vehicle is arranged to move in a predetermined trajectory by means of a fluid stream passing the wing during operation of the submersible power plant.

### BACKGROUND OF THE DISCLOSURE

Current solutions of submersible power plants normally have one or more turbines placed such that it is the first thing that encounters the stream in which the submersible power plant is operating. This setup introduces a lot of drag to the submersible power plant that leads to reduced efficiency if the submersible power plant is moving and/or to that increased strength of the materials used is needed in order not to break apart due to the increased loads on the submersible power plant from the increased drag. This will lead to increase cost for design and maintenance of the submersible power plant.

There is thus a need for an improvement within the field of submersible power plants.

### SUMMARY OF THE DISCLOSURE

One object of the present invention is to provide an inventive submersible power plant that addresses the previously mentioned problems. This object is achieved by the features of the characterising portion of claim 1. Variations of the invention are described in the appended dependent claims.

The invention relates to a submersible power plant for producing electrical power. The submersible power plant comprises a structure and a vehicle comprising at least one wing. The vehicle is arranged to be secured to the structure by means of at least one tether and the vehicle is arranged to move in a predetermined trajectory by means of a fluid stream passing the wing during operation of the submersible power plant. The submersible power plant further comprises at least one turbine connected to a generator, where the at least one turbine is connected to a rear edge of the wing and wherein the generator is arranged inside the wing of the vehicle.

One advantage with a submersible power plant according to the disclosure is that placing the turbine behind the wing and placing the generator inside the wing of the vehicle makes it easier to design and build a vehicle with a smaller distance between the centre of gravity and the centre of buoyancy. This makes it possible to start the vehicle in lower tidal flow speeds.

The fluid passing the wing is also not disturbed by the turbine, as the wake from the turbine is generated behind the wing.

Further, with the turbine attached to a rear edge of the wing, it is possible to eliminate the need for long struts in order to attach the tether to the vehicle. This results in that the vehicle will have a smaller vertical footprint, which will make onshore operations as well as offshore deployment and retrieval easier as it will be easier to lift the vehicle in and out of the water and to tow it to its site. Onshore operations as well as offshore deployment and retrieval will also be safer as all moving parts are located at the rear of the vehicle. This makes it safer for service personnel either in water, on a towing vessel offshore or onshore to approach the vehicle. The towing speed with which the vehicle can be towed to/from the installation site is also affected by the design of the vehicle. By having the turbine arranged at the rear of the vehicle, towing can now be performed at approximately 5-10 times higher speeds than is possible today. The design of the vehicle no longer limits the tow speed, as was the case with vehicles having a nacelle arranged underneath the wing. Instead, the towing vessels speed and the tether load will be the limiting factor for the towing speed. This leads to that towing of the vehicle can be performed in more varied weather conditions than is possible with a vehicle where the turbine is arranged in a nacelle under the wing, which increases the availability of the power plant.

Further, having the generator placed inside the wing makes it possible to design the wing without load-bearing internal beams that would otherwise be necessary.

Further, having a rear mounted turbine makes it easier to scale the vehicle in a way that is not possible with today's vehicle where the turbine is mounted underneath the wing. For example, the wing's performance can be optimized for a certain location, and turbines with different diameters can be attached to the wing. As the turbine is attached to the rear, the wing's performance is not affected by the turbine size. Further, the length of the tether connecting the structure and the vehicle can more easily be adapted to various installation depths.

In addition, the temperature of the generator can be controlled to a much higher degree. Having the generator arranged inside the wing, makes it possible to design cooling channels with openings directly from the wing to the generator. In this way, the volume of cooling fluid cooling the generator can be controlled with greater accuracy than today where the generator is arranged in a nacelle underneath the wing.

The wing of the vehicle of the submersible power plant may comprise winglets. In order to increase the manoeuvrability of the vehicle and increase lift, the wings can be designed with winglets.

The winglets may have a winglet span in a range of 1/10 to ½ of the wing's wingspan, more specifically ⅛ to ⅓ of the wing's wingspan. In order to achieve a desired effect of the winglets, the winglets' span should be within a range of 1/10 to ½ of the wing's wingspan.

The vehicle may comprise a control mechanism arranged on nacelles attached to a rear edge of the wing. The vehicle may alternatively comprise a control mechanism arranged on a rear edge of the wing. The control mechanism arranged on the rear edge of the wing may comprise control surfaces in the form of for instance water brake, elevons/tailerons or duckerons/decelerons/split ailerons. As the vehicle moves along its predetermined trajectory, it is necessary to control the vehicles motion with a control mechanism. The control mechanism can take different forms, for instance, the control mechanism can be arranged on nacelles attached to a rear edge of the wing or the control mechanism can be arranged on a rear edge of the wing.

During operation, the wing may traverse the predetermined trajectory at an angle of attack of between 5°-20° relative the resultant flow approaching the vehicle, specifically between 8°-14° relative the resultant flow approaching the vehicle.

The wing may direct the fluid stream passing the wing towards the turbine. By operating the vehicle at specific angles of attack, a more consistent approach angle of the fluid towards a rotational axis of the turbine for different angles of attack of the wing due to lower radial components of the fluid can be achieved, resulting in lower drag for the entire vehicle, which increases total system output. This feature also has a small negative effect on lift and therefore on the glide ratio, but to a much lesser extent than the positive effects gained.

The thrust force on the turbine has a component moving downwards. Downwards in this context is in relation to the direction of the flow approaching the vehicle, which is a combination of device movement and tidal speed. The flow direction relative the vehicle dictates which direction of travel of the vehicle that causes drag. Since the function of the wing could be described as giving the flow passing over the wing an impulse downwards, thus deviating from the drag direction and instead creating down force which is something negative for glide ratio. The glide ratio decrease from marginally lower lift is much less than the increase in glide ratio because of less drag.

A pitch of the wing in the middle of the wing is between approximately 5-30°, specifically between approximately 8-25°. This results from for instance the nacelle having a cambered profile as its base shape. The wing in front of the turbine could alternatively or supplementary have a very long chord length. Further, the profiles of the nacelle, if present, and wing can be designed with a lift coefficient of between approximately 0.6-1.

The tether may be attached directly to the wing. In other vehicles, struts have been used to attach the tether to the vehicle. With the present configuration, struts that may otherwise be needed can be removed which simplifies handling of the vehicle.

The wing of the vehicle may be backswept. A backswept wing will provide the possibility of locating the winglet behind the top joint in a length direction of the vehicle. This provides yaw stability when the vehicle is in a parked state, i.e. stationary in the fluid. Further, the winglet may be located closer to the turbine in a length direction of the vehicle, which is beneficial for the flow direction of the fluid towards the turbine. It also pushes the yaw centre backwards and the centre of buoyancy backwards.

### BRIEF DESCRIPTION OF THE FIGURES

FIG. 1 schematically shows a submersible power plant according to a first example embodiment,

FIG. 2 schematically shows a submersible power plant according to a second example embodiment.

### DETAILED DESCRIPTION OF THE DISCLOSURE

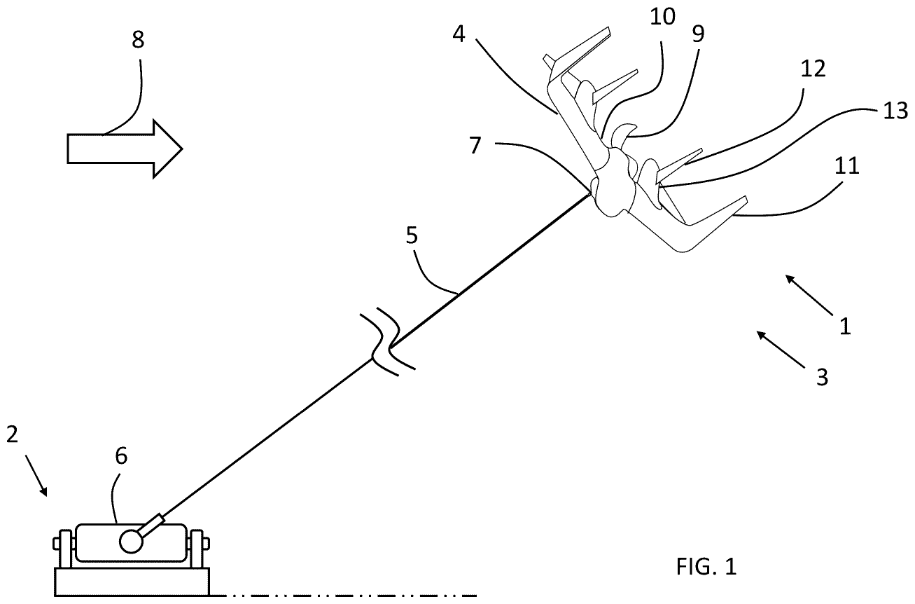

FIG. 1 schematically shows a submersible power plant 1 according to a first example embodiment. The submersible power plant 1 comprises a structure 2 attached either to the sea floor or to a floating structure. In FIG. 1, the structure 2 is attached to the sea floor. The structure 2 of the submersible power plant 1 can also be attached to a streambed or to a lake floor. A sea surface of the body of water the submersible power plant 1 is installed in is not visible in FIG. 1.

The submersible power plant 1 comprises a vehicle 3 comprising at least one wing 4 where the vehicle 3 is arranged to be secured to the structure 2 by means of at least one tether 5 by a bottom joint 6 on the structure 2 and a top joint 7 on the vehicle 3. The submersible power plant 1 is arranged to produce electrical power from that the vehicle 3 is arranged to move in a predetermined trajectory by means of a fluid stream passing the wing 4 during operation of the submersible power plant 1. The predetermined trajectory is essentially in a plane perpendicular to the direction of an underwater stream, such as a tidal stream, ocean stream, river stream or similar. The direction of the tidal stream is schematically illustrated by an arrow 8 in the figure.

The submersible power plant 1 comprises a turbine 9 connected to a generator arranged inside the wing 4, where the turbine 9 rotates from the flow of fluid passing the turbine 9). The turbine 9 in turn rotates the generator, which produces electrical energy. Arranging the generator inside the wing 4 makes it possible to design a wing 4 without as many integral structural parts, e.g. load-bearing beams, making the wing 4 and the entire power plant 1 easier to design as well as making the power plant 1 less expensive. The vehicle's structural integrity is also improved.

By having the generator inside the wing 4, a space inside the wing 4 where the generator is arranged can be made bigger than for a vehicle having a nacelle underneath the wing 4. Having a larger nacelle arranged underneath the wing 4 negatively affects the wing's 4 lift. This bigger space can be utilized for making the generator bigger, or for installing additional equipment besides the generator. One example of additional equipment is a kinetic energy storage system arranged to store kinetic energy from the turbine 9 that due to delivery limitations in the onshore grid or by design is not converted into electrical energy by the generator. The kinetic energy storage can be used to rotate the generator to generate electric energy when delivery limitations are removed or to generate electrical energy during parts of the predetermined trajectory where the turbine 9 spins slower than during an operational speed. In this way, an equal amount of electric energy can be delivered by the vehicle 3 the entire predetermined trajectory.

That the predetermined trajectory is essentially in a plane perpendicular to the direction of an underwater stream will make the vehicle 3 accelerate to a velocity many times greater than the velocity of the underwater stream, thereby increasing the velocity of the stream passing the turbine 9. This increases the amount of power that can be generated from tidal or ocean currents that are normally too slow moving to be used for other types of underwater submersible power plants. The electrical energy generated by the generator is transferred from the generator via the tether 5 to the structure 2 to an on-shore power grid from where the electrical energy is distributed to end users such as homes or businesses. The on-shore power grid can be a stand-alone power grid or a power grid that connects to a main power grid.

The power generation of the submersible power plant is described in more detail on the applicant's webpage: see for instance https://minesto.com/our-technology.

The turbine 9 is connected to a rear edge 10 of the wing 4 and the generator is arranged inside the wing 4 of the vehicle 3. It is possible to have more than one turbine 9 attached to the rear edge 10 of the wing 4, where each turbine 9 may be connected to a separate generator inside the wing 4 of the vehicle 3 or to the same generator inside the wing 4 of the vehicle 3.

The wing 4 of the vehicle 3 comprises winglets 11 to reduce wingtip vortices that increase drag. The winglets 11 have a winglet span in a range of 1/10 to ½ of the wing's 4 wingspan, more specifically ⅛ to ⅓ of the wing's 4 wingspan in order to achieve the desired effect.

In the example of FIG. 1, the wing 4 of the vehicle 3 is backswept. The vehicle 3 may also have an unswept wing or a forward swept wing.

In order to control the vehicle 3 as it traverses its predetermined trajectory, the vehicle 3 comprises a control mechanism 12 arranged on nacelles 13 attached to the rear edge 10 of the wing 4. A vehicle control system controls the control mechanism 12 to steer the vehicle 3 along the predetermined trajectory, which can be in the shape of a figure eight, circular, oval or other suitable shapes. In FIG. 1, the control mechanism 12 comprises two separate sets of elevators and rudders attached to separate nacelles 13. By arranging the turbine 9 at the rear of the vehicle 3, the turbine 9 will be placed closer to the vehicle's 3 centre of rotation. One effect is that the radial component of the flow towards the turbine 9 is reduced. This improves the vehicle's 3 performance.

The vehicle control system is powered and controlled through power and control cables running inside the tether 5, which in turn are connected to an on-shore control centre that oversees and controls the submersible power plant 1. Many submersible power plants that are connected to the on-shore control centre make up a site with a nominal power output.

The wing 4 directs the fluid stream passing the wing 4 towards the turbine 9. The wing 4 may direct the fluid stream passing the wing 4 towards the turbine 9. During energy generation, i.e. during operation, the wing 4 traverses the predetermined trajectory at an angle of attack of between 5°-20° relative the resultant flow approaching the vehicle 3, specifically between 8°-14°. This gives a more consistent flow pattern for different pitch angles than having the turbine 9 unaffected by the vehicle 3, which would be the case if the turbine 9 were mounted at the front of the vehicle 3.

The thrust force on the turbine 9 resulting from the angle of attack of the wing 4 has a component moving downwards. Downwards in this context is in relation to the direction of the flow approaching the vehicle 3, which is a combination of device movement and tidal speed, as shown in FIG. 1. The flow direction of the underwater stream relative the vehicle 3 dictates which direction of travel of the vehicle 3 that causes drag. Since the function of the wing 4 can be described as giving the flow passing over the wing 4 an impulse downwards, thus deviating from the drag direction and instead creating down force, which is something negative for glide ratio.

A pitch of the wing 4 in the middle of the wing 4 is between approximately 5-30°, specifically between approximately 8-25°.

In the example embodiment of FIG. 1, the tether 5 is attached directly to the wing 4. By not using a nacelle underneath the wing 4 that houses the turbine 9 and generator, it is possible to attach the tether 5 directly to the wing 4. This allows for a reduction in height of the vehicle 3, as struts are no longer needed. This leads to easier onshore handling as well as deploying the vehicle 3 into the fluid at its site and lifting the vehicle 3 out of the fluid for repairs or upgrades. It is of course possible to use struts as an alternative as previously known.

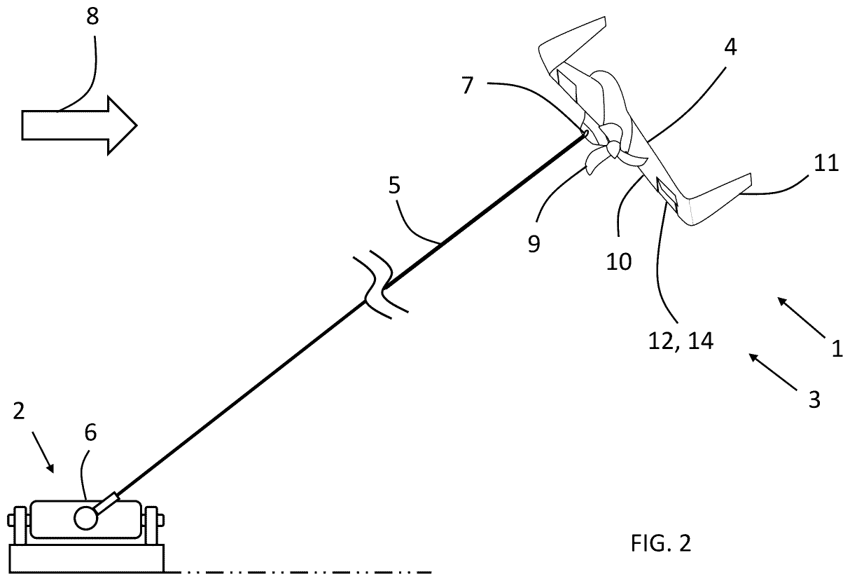

FIG. 2 schematically shows a submersible power plant 1 according to a second example embodiment. The vehicle 3 of the submersible power plant 1 of FIG. 2 is similar to the one in FIG. 1 with the difference that the control mechanism 12 comprises control surfaces 14 in the form of elevons arranged at the rear edge 10 of the wing 4 instead of a control mechanism 12 arranged on nacelles 13 attached to a rear edge 10 of the wing 4 as in FIG. 1. This kind of control mechanism removes the need for nacelles to arrange the separate rudder and elevator on, leading to a smaller vehicle 3 and reduced drag.

One advantage with a vehicle design according to the one above is that during power loss, when the vehicle 3 loses power to its control system, a rear mounted turbine 9 leads to that the design of the wing 4 itself causes the vehicle 3 to stop in the water which enables the vehicle 3 to remain parked at a safe depth until power is restored or the vehicle 3 can be retrieved.

Further, the flow velocity over the turbine 9 is higher when the turbine 9 is connected to the rear edge 10 of the wing 4 than when the turbine 9 is arranged in front of or below the wing 4.

Reference signs mentioned in the claims should not be seen as limiting the extent of the matter protected by the claims, and their sole function is to make claims easier to understand.

As will be realised, the invention is capable of modification in various obvious respects, all without departing from the scope of the appended claims. Accordingly, the drawings and the description are to be regarded as illustrative in nature, and not restrictive.

1. A submersible power plant for producing electrical power, the submersible power plant comprising a structure and a vehicle comprising at least one wing, the vehicle being arranged to be secured to the structure by means of at least one tether, the vehicle being arranged to move in a predetermined trajectory by means of a fluid stream passing the wing during operation of the submersible power plant, characterized in that the submersible power plant further comprises at least one turbine connected to a generator, wherein the at least one turbine is connected to a rear edge of the wing and wherein the generator is arranged inside the wing of the vehicle.

2. The submersible power plant of claim 1, wherein the wing comprises winglets.

3. The submersible power plant of claim 2, wherein the winglets have a winglet span in a range of 1/10 to ½ of the wing's wingspan, more specifically ⅛ to ⅓ of the wing's wingspan.

4. The submersible power plant of claim 1, wherein the vehicle comprises a control mechanism arranged on nacelles attached to the rear edge of the wing.

5. The submersible power plant of claim 1, wherein the vehicle comprises a control mechanism arranged on the rear edge of the wing.

6. The submersible power plant of claim 5, wherein the control mechanism comprises control surfaces in the form of elevons or duckerons.

7. The submersible power plant of claim 1, wherein during operation, the wing traverses the predetermined trajectory at an angle of attack of between 5°-20° relative the resultant flow approaching the vehicle, specifically between 8°-14° relative the resultant flow approaching the vehicle.

8. The submersible power plant of claim 7, wherein the fluid stream passing the wing is directed towards the turbine.

9. The submersible power plant of claim 8, wherein a thrust force on the turbine resulting from the angle of attack of the wing is directed downwards.

10. The submersible power plant of claim 1, wherein a pitch of the wing in the middle of the wing is between approximately 5-30°, specifically between approximately 8-25°.

11. The submersible power plant of claim 1, wherein the tether is attached directly to the wing.

12. The submersible power plant of claim 1, wherein the wing of the vehicle is backswept.
